(19) United States
(12) Patent Application Publication
(10) Pub. No.: US 2014/0016827 A1
(43) Pub. Date: Jan. 16, 2014

(54) IMAGE PROCESSING DEVICE, IMAGE PROCESSING METHOD, AND COMPUTER PROGRAM PRODUCT

(71) Applicant: KABUSHIKI KAISHA TOSHIBA, Minato-ku (JP)

(72) Inventors: Takuma YAMAMOTO, Kanagawa (JP); Yasunori TAGUCHI, Kanagawa (JP); Toshiyuki ONO, Kanagawa (JP); Nobuyuki MATSUMOTO, Tokyo (JP)

(21) Appl. No.: 13/937,495

(22) Filed: Jul. 9, 2013

(30) Foreign Application Priority Data
Jul. 11, 2012 (JP) 2012-155965

(51) Int. Cl. G06T 5/00

(52) U.S. Cl. CPC G06T 5/003
USPC 382/106

(57) ABSTRACT

According to an embodiment, an image processing device includes a generator, a determinator, and a processor. The generator is configured to generate a refocused image focused at a predetermined distance from a plurality of unit images for which points on an object are imaged at different positions according to distances between an imaging unit and the positions of the points on the object by the imaging unit. The determinator is configured to determine sampling information including pairs of positions of pixels of the plurality of unit images in the refocused image and pixel values of the pixels. The processor is configured to perform resolution enhancement on a predetermined region including a first position indicated by the sampling information of the refocused image according to an intensity corresponding to a focusing degree of a pixel corresponding to the first position.

### CROSS-REFERENCE TO RELATED APPLICATION

This application is based upon and claims the benefit of priority from Japanese Patent Application No. 2012-155965, filed on Jul. 11, 2012; the entire contents of which are incorporated herein by reference.

### FIELD

Embodiments described herein relate generally to an image processing device, an image processing method, and a computer program product.

### BACKGROUND

There are known a light-field camera including a microlens array, camera array, or the like that simultaneously captures a plurality of images of the same object. In each of the images, a slightly different part of the same object, which is slightly shifted from each other, is shown. Thus, it is possible to reconstruct an image focused at any distance designated for the image by shifting and integrating the plurality of images. Such reconstructed image is referred to as a refocused image.

As described above, the refocused image is generated by shifting and integrating images captured by respective microlenses of the microlens array. Therefore, since the number of pixels of the refocused image decreases more than the number of pixels of an imaging element, there is a problem that a resolution deteriorates and image quality thus deteriorates.

### BRIEF DESCRIPTION OF THE DRAWINGS

FIG. 1 is a block diagram illustrating an example of the configuration of an image processing device according to a first embodiment;

FIG. 2 is a diagram schematically illustrating an example of the configuration of an acquisition unit according to the first embodiment;

FIG. 3 is a schematic diagram schematically illustrating an example of an image captured and acquired by the acquisition unit according to the first embodiment;

FIG. 4 is a flowchart illustrating an example of a process of an image processing device according to the first embodiment;

FIG. 5 is a diagram illustrating a process of generating a refocused image in more detail according to the first embodiment;

FIG. 6 is a diagram illustrating the degree of focus according to the first embodiment;

FIG. 7 is a diagram illustrating the degree of focus according to the first embodiment;

FIG. 8 is a diagram illustrating a method of setting the degree of focus in more detail according to the first embodiment;

FIG. 9 illustrates a process of determining sampling information in more detail according to the first embodiment;

FIG. 10 is a block diagram illustrating an example of the configuration of an imaging device according to a second embodiment;

FIG. 11 is a block diagram illustrating an example of the configuration of a sensor device according to a third embodiment;

FIG. 12 is a block diagram illustrating an example of the configuration of an image processing system according to a fourth embodiment; and

FIG. 13 is a block diagram illustrating an example of the configuration of a computer device to which the image processing device is applicable according to another embodiment.

### DETAILED DESCRIPTION

According to an embodiment, an image processing device includes a generator, a determinator, and a processor. The generator is configured to generate, from a plurality of unit images in which points on an object are imaged by an imaging unit at different positions according to distances between the imaging unit and the positions of the points on the object, a refocused image focused at a predetermined distance. The determinator is configured to determine sampling information including pairs of positions of pixels of the plurality of unit images in the refocused image and pixel values of the pixels. The processor is configured to perform resolution enhancement on a predetermined region including a first position indicated by the sampling information of the refocused image according to an intensity corresponding to a focusing degree of a pixel corresponding to the first position.

### First Embodiment

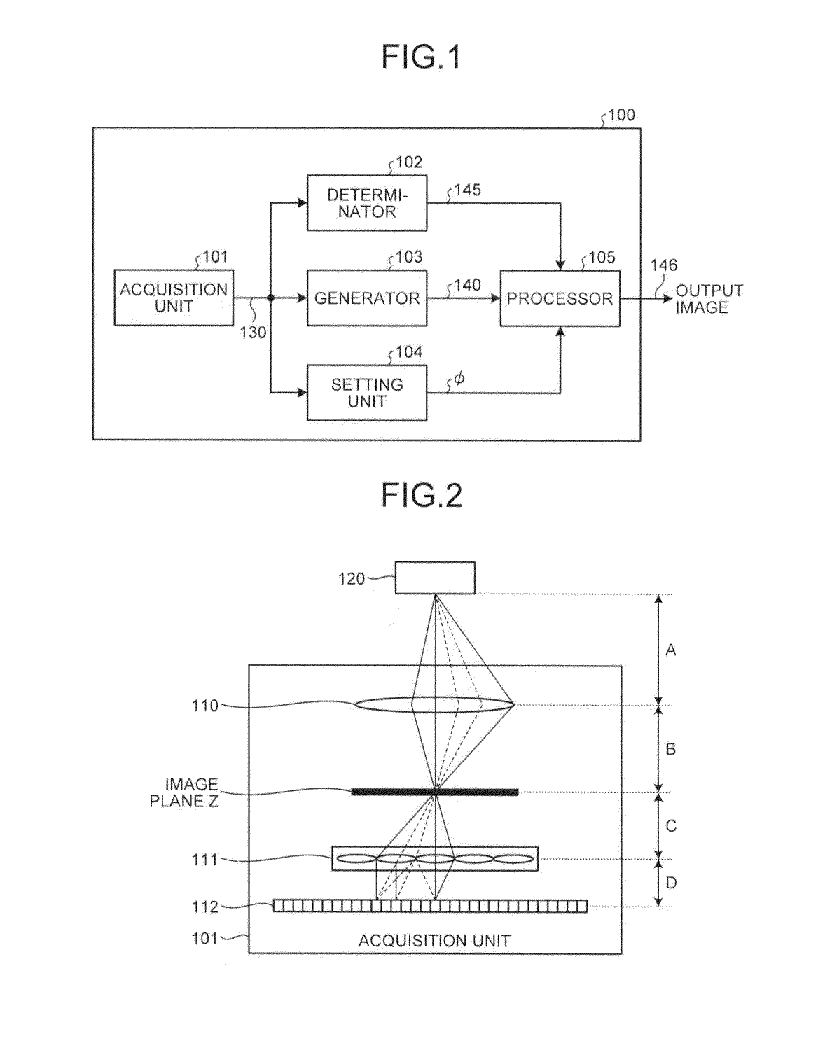

Hereinafter, an image processing device according to a first embodiment will be described. FIG. 1 illustrates an example of the configuration of an image processing device 100 according to the first embodiment. The image processing device 100 performs a process on an image acquired by an acquisition unit 101 according to the first embodiment. The image processing device 100 includes a determinator 102 that determines sampling information, a generator 103 that generates a refocused image, a setting unit 104 that sets the degree of focus, and a processor 105 that performs resolution enhancement. The determinator 102, the generator 103, the setting unit 104, and the processor 105 may be configured by cooperating hardware, or some or all thereof may be configured by a program operating on a CPU (Central Processing Unit).

The acquisition unit 101 acquires a plurality of unit images for which positions of points on an object are captured at different positions according to distances between the acquisition unit 101 and the positions on the object.

FIG. 2 is a diagram schematically illustrating an example of the configuration of the acquisition unit 101 according to the first embodiment. In the example of FIG. 2, the acquisition unit 101 includes an imaging optical system that includes a main lens 110 imaging light from an object 120, a microlens array 111 in which a plurality of microlenses is arrayed, and an optical sensor 112. In the example of FIG. 2, the main lens 110 is set such that an imaging plane of the main lens 110 is located between the main lens 110 and the microlens array 111 (in an imaging plane Z).

Although not illustrated, the acquisition unit 101 further includes a sensor driving unit that drives a sensor. Driving of the sensor driving unit is controlled according to a control signal from the outside.

The optical sensor 112 converts the light imaged on a light reception surface by each microlens of the microlens array 111 into an electric signal and outputs the electric signal. For example, a CCD (Charge Coupled Device) image sensor or a CMOS (Complementary Metal Oxide Semiconductor) image sensor can be used as the optical sensor 112. In such an image sensor, light-receiving elements corresponding to respective pixels are configured to be arrayed in a matrix form on the light reception surface. Thus the light is converted into the electric signal of each pixel through photoelectric conversion of each light-receiving element and the electric signal is output.

The acquisition unit 101 causes the optical sensor 112 to receive light incident on a position on the microlens array 111 from a given position on the main lens 110 and outputs an image signal including a pixel signal of each pixel. An imaging device having the same configuration as the acquisition unit 101 is known as the name of a light-field camera or a plenoptic camera.

The imaging plane of the main lens 110 in the acquisition unit 101 located between the main lens 110 and the microlens array 111 has been described above, but the invention is not limited to this example. For example, the imaging plane of the main lens 110 may be set on the microlens array 111 or may be set to be located on the rear side of the optical sensor 112. When the imaging plane of the main lens 110 is located on the rear side of the optical sensor 112, a microlens image 131 formed in the optical sensor 112 is a virtual image.

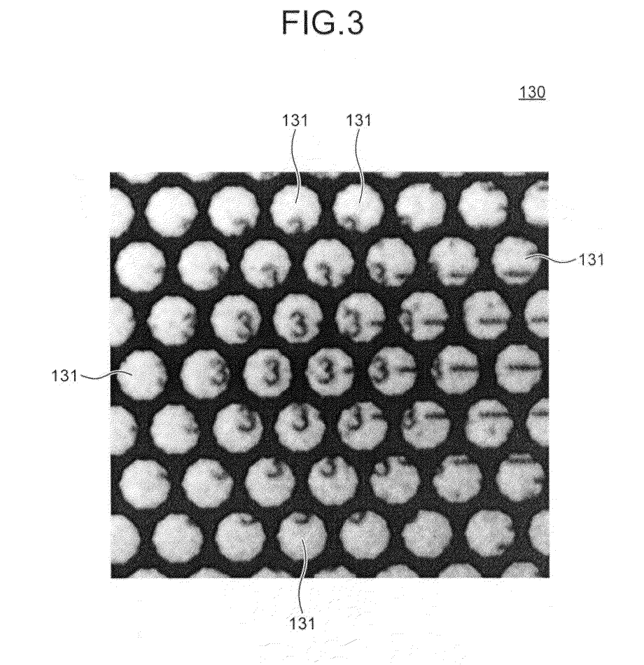

FIG. 3 is a diagram schematically illustrating an example of an image captured and acquired by the acquisition unit 101 in which the imaging plane of the main lens 110 is located on the rear side of the optical sensor 112. The acquisition unit 101 acquires an image 130 in which images 131 formed on the light reception surface of the optical sensor 112 by the respective microlenses of the microlens array 111 are disposed in correspondence with the array of the microlenses. In FIG. 3, it can be understood that the same object (for example, a numeral “3”) is captured to be shifted by a predetermined amount in the respective images 131 according to the array of the microlenses.

Hereinafter, the image 130 in which the images 131 are disposed according to the array of the respective microlenses of the microlens array 111 is referred to as a compound-eye image 130. Each image 131 is a unit image which serves as units forming the compound-eye image 130.

Each image 131 by each microlens is preferably formed on the optical sensor 112 without overlap. Since each image 131 in the compound-eye image 130 captured by the optical system exemplified in FIG. 2 is a real image, an image formed by extracting each image 131 and inversing the image 131 to the right, left, upper, and lower sides is referred to as a microlens image 131. The description will be made below using the microlens image as the unit image. That is, an image formed by one microlens is the microlens image 131 and an image formed by arraying the plurality of microlens images 131 is the compound-eye image 130.

FIG. 3 illustrates the example of the compound-eye image 130 when the microlenses of the microlens array 111 are arrayed on hexagonal lattice points. However, the array of the microlenses is not limited to this example, but another array of the microlenses may be used. For example, the microlenses may be arrayed on tetragonal lattice points.

Here, in the configuration of FIG. 2, the entirety of the object 120 or small regions in the object 120 are shifted little by little according to the positions of the respective microlenses, and thus light from the object 120 is imaged as the respective microlens images 131 (see FIG. 3). That is, the acquisition unit 101 acquires two or more microlens images 131 captured in a state in which the positions of points of interest on the object 120 captured commonly by two or more microlenses are shifted according to distances up to the respective points of interest of the two or more microlenses. In other words, the acquisition unit 101 acquires the plurality of microlens images 131 for which the points of interest are captured at different positions according to the distances from the plurality of microlenses.

The example has been described above in which the acquisition unit 101 uses the microlens array 111 in which the plurality of microlenses is arrayed, but the invention is not limited to this example. For example, the acquisition unit 101 may use a camera array in which a plurality of cameras is arrayed. A configuration in which the camera array is used can be considered as a configuration in which the main lens 110 is omitted in the configuration of FIG. 2. When the camera array is used, an image captured by each camera is a unit image and an output image of the entire camera array is a compound-eye image.

Referring back to FIG. 1, the generator 103 generates a refocused image 140 focused to a given object at a distance designated as a distance from the acquisition unit 101 (the main lens 110) from the compound-eye image 130 acquired by the acquisition unit 101. The determinator 102 calculates the position of each pixel of the compound-eye image 130 acquired by the acquisition unit 101 in the refocused image 140 with real precision. That is, the position calculated here is not suitable for the matrix of the pixels in some cases. The determinator 102 also determines sampling information 145 including a pair of the position and a pixel value of the pixel of the compound-eye image 130 corresponding to this position.

The processor 105 performs the resolution enhancement on a predetermined region including a predetermination position of the refocused image 140 indicated by the sampling information 145 according to an intensity corresponding to the focusing degree of a pixel corresponding to the predetermined position based on the refocused image 140 output from the generator 103 and the sampling information 145 output from the determinator 102. A high-resolution image 146 obtained by performing the resolution enhancement on the refocused image 140 by the processor 105 is output as an output image from the image processing device 100.

The resolution enhancement in the processor 105 is performed in more detail as follows. The setting unit 104 sets the degree of focus φ indicating the focusing degree for each pixel of the refocused image 140 from the compound-eye image 130 acquired by the acquisition unit 101. In this case, the degree of focus φ is set to indicate a larger value, when focus is further achieved (the focusing degree is high). The setting unit 104 may set the degree of focus φ by generating the refocused image from the compound-eye image 130, as in the generator 103 or may set the degree of focus φ using a processing result of the generator 103 or a calculation value in progress of a processing result. The processor 105 performs the resolution enhancement more intensively based on the degree of focus φ output from the setting unit 104, as the degree of focus φ is larger.

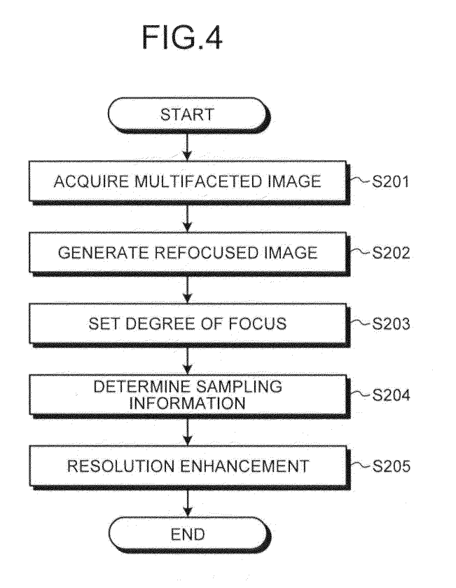

FIG. 4 is a flowchart illustrating an example of a process of the image processing device 100 according to the first embodiment. In step S201, the acquisition unit 101 first acquires the compound-eye image 130. The acquired compound-eye image 130 is supplied to each of the determinator 102, the generator 103, and the setting unit 104. Next, in step S202, the generator 103 generates the refocused image 140 of which the focus position is changed from the compound-eye image 130 supplied in step S201 from the acquisition unit 101. Next, in step S203, the setting unit 104 sets the degree of focus φ for each pixel of the refocused image 140 from the compound-eye image 130 supplied in step S201 from the acquisition unit 101.

Next, in step S204, the determinator 102 determines the sampling information 145 based on the compound-eye image 130 supplied in step S201 from the acquisition unit 101. Then, in step S205, the processor 105 performs the resolution enhancement on the refocused image 140 using the refocused image 140 generated and determined in step S202 to step S204, the degree of focus φ, and the sampling information 145.

The process of generating the refocused image in step S202 will be described. In step S202, the generator 103 generates the refocused image 140 focused at a predetermined distance oriented from the acquisition unit 101 (the main lens 110) to the object 120 from the compound-eye image 130 supplied from the acquisition unit 101. The predetermined distance may be a distance determined in advance or may be designated through a user's input or the like on an input unit (not illustrated).

The generator 103 generates the refocused image 140 by scaling up and integrating the unit images at a scale factor corresponding to the focusing distance. As described with reference to FIG. 3, the compound-eye image 130 is obtained by contracting and imaging the object by the plurality of microlenses. Therefore, the refocused image 140 can be generated by scaling up and integrating the individual microlens images 131 at a predetermined scale factor.

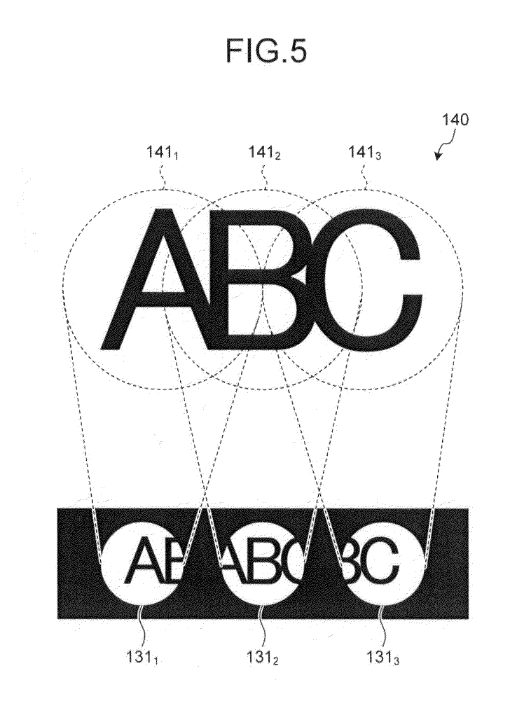

The process of generating the refocused image will be described in more detail with reference to FIG. 5. To facilitate the description here, a case will be described in which three microlens images 131₁, 131₂, and 131₃ are lined up in a line. Images 141₁, 141₂, and 141₃ are generated by scaling up the microlens images 131₁, 131₂, and 131₃ at a predetermined scale factor. The images 141₁, 141₂, and 141₃ are shifted at an amount of shift according to the focus distance and are integrated. Thus, the same points of the same object contained in the images 141₁, 141₂, and 141₃ are integrated. For example, the generator 103 calculates the average value of the pixel values for which the positions of the integrated images 141₁, 141₂, and 141₃ accord with each other and generates the refocused image 140 based on the pixels having the average value as a pixel value.

Thus, the refocused image 140 is generated by integrating the images 141₁, 141₂, and 141₃ scaled up respectively from the microlens images 131₁, 131₂, and 131₃. By changing the scale factor of the microlens images 131₁, 131₂, and 131₃, it is possible to generate the refocused image 140 of which the focus distance is changed with respect to a focus distance at the time of photographing.

The microlens images 131 can be scaled up using, for example, a nearest neighbor method, a bilinear method, a bicubic method. When a plurality of images captured by the camera array is used, the refocused image 140 can be generated by scaling up the images at a predetermined magnification, shifting the images at an amount of shift according to a desired focus distance, and integrating the images.

A relation between the a focusing distance and a scale factor of the microlens image 131 which is the unit image will be described with reference to FIG. 2. The imaging plane Z indicates an imaging plane of an image generated through a refocus process. A distance A indicates a distance between the object 120 desired to be focused and the main lens 110. A distance B indicates a distance between the main lens 110 and the imaging plane Z. A distance C indicates a distance between the imaging plane Z and the microlens array 111. A distance D indicates a distance between the microlens array 111 and the optical sensor 112. An image of the object 120 for which a distance from the main lens 110 is the distance A is assumed to be formed on the imaging plane Z.

To generate an image on the imaging plane Z, the microlens images 131 may be scaled up C/D times, may be shifted by an amount corresponding to the size of an image to be output, and may be integrated. At this time, the distance A and the distance B have a one-to-one correspondence relation from a property of a lens. Therefore, when “the distance B+the distance C” is set to a fixed distance K, the distance A and the distance C have a one-to-one correspondence relation. Thus, by performing inverse operation from the distance A and determining the value of the distance C, a scale factor of the microlens image 131 can be determined.

The process of setting the degree of focus in step S203 of the flowchart of FIG. 4 will be described. In step S203, the setting unit 104 sets the degree of focus φ of a value according to the focusing degree in the refocused image 140 based on the input compound-eye image 130 for each pixel and outputs the degree of focus φ. More specifically, the setting unit 104 sets the degree of focus φ of a larger value as the focusing degree is higher.

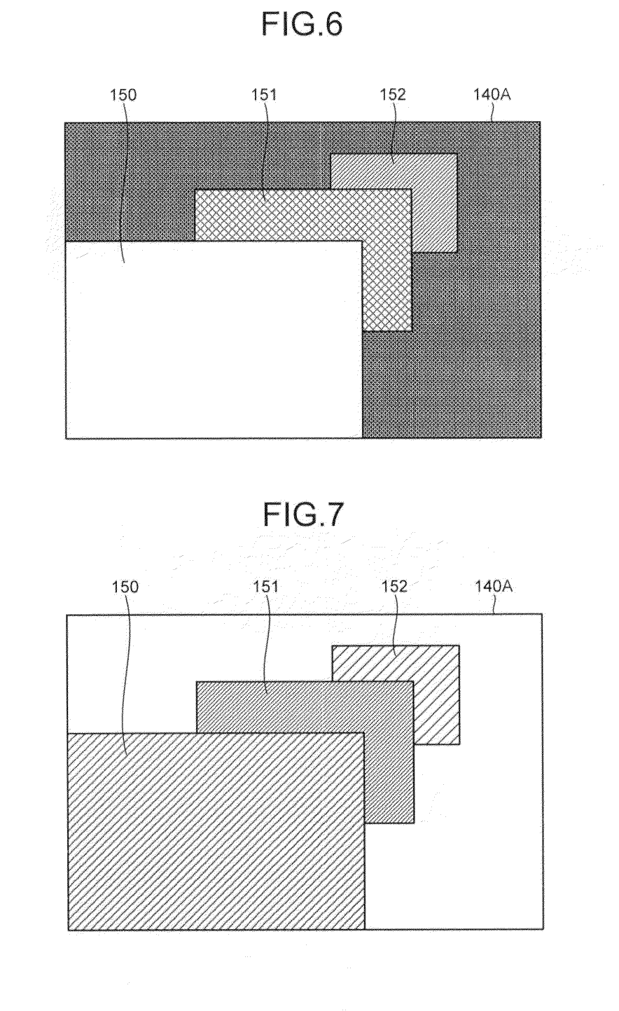

For example, the refocused image 140 exemplified in FIG. 6 is considered. A refocused image 140A contains three images 150, 151, and 152 of an object for which distances from the acquisition unit 101 (the main lens 110) are different. The object of the image 150 is the shortest from the acquisition unit 101 and the object of the image 152 is the farthest from the acquisition unit 101. Further, in the refocused image 140A, a region other than the images 150, 151, and 152 is set as a background and is assumed to be farther from the acquisition unit 101 than the image 152. In the refocused image 140A, the image 151 is focused (the focusing degree is high). Hereinafter, the image 150, the image 152, and the background become out of focus in this order (the focusing degree is low).

FIG. 7 is a diagram illustrating an example of setting of the degree of focus φ in the refocused image 140A. In the example of FIG. 7, denser hatching is given and illustrated, as the degree of focus φ increases. Of the images 150, 151, and 152 and the background, the focused image 151 is considered to have the highest value of the degree of focus φ. Hereinafter, the lower the focusing degree is, the lower the value of the degree of focus φ is.

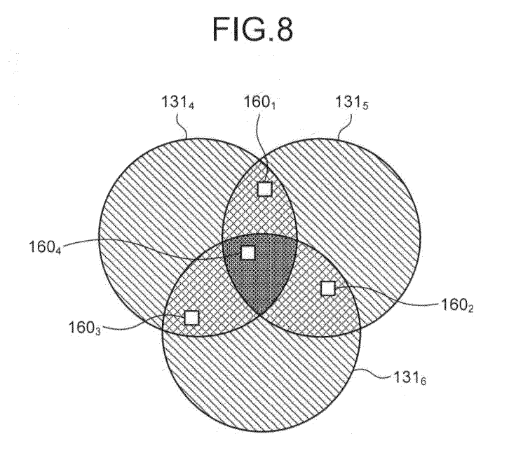

The method of setting the degree of focus φ will be described in more detail with reference to FIG. 8. FIG. 8 illustrates a case in which three microlens images 131₄, 131₅, and 131₆ are scaled up at a predetermined scale factor and are integrated. In a focused region, a variation in the pixel value of a integrated region is small when the microlens images 131 are integrated. Therefore, for example, the degree of focus φ can be calculated using a variance of the pixel values.

A value m₁(x) indicates a pixel value of the microlens image 131₄ in a position vector x, a value m₂(x) indicates a pixel value of the microlens image 131₅, and a value m₃(x) indicates a pixel value of the microlens image 131₆. Further, a value m̅(x) indicates an average of the pixel values in the position vector x.

When a vector x₁ is assumed to be a position vector of a position 160₁, a variance ρ(x₁) of the pixel values in the pixel position 160₁ can be calculated by Equation (1) below.

$$ρ ( {x}_{1} ) = \frac{1}{2} {\sum }_{i = 1 , 2}^{ } {( {m}_{i} ( {x}_{1} ) - \overline{m} ( {x}_{1} ) )}^{2} \qquad ( 1 )$$

It is assumed that vectors x₂, x₃, and x₄ are position vectors of pixel positions 160₂, 160₃, and 160₄. As in Equation (1), variances ρ(x₂), ρ(x₃), and ρ(x₄) of pixel values in pixel positions 160₂, 160₃, and 160₄ can be calculated by Equation (2) to Equation (4) below, respectively.

$$\begin{matrix}ρ ( {x}_{2} ) = \frac{1}{2} {\sum }_{i = 2 , 3}^{ } {( {m}_{i} ( {x}_{2} ) - \overline{m} ( {x}_{2} ) )}^{2} & ( 2 ) \\ ρ ( {x}_{3} ) = \frac{1}{2} {\sum }_{i = 1 , 3}^{ } {( {m}_{i} ( {x}_{3} ) - \overline{m} ( {x}_{3} ) )}^{2} & ( 3 ) \\ ρ ( {x}_{4} ) = \frac{1}{3} {\sum }_{i = 1 , 2 , 3}^{ } {( {m}_{i} ( {x}_{4} ) - \overline{m} ( {x}_{4} ) )}^{2} & ( 4 )\end{matrix}$$

Likewise, a variance p of a pixel value can be calculated for all of the pixel positions. The degree of focus φ(x) in a position vector x can be calculated by Equation (5) below using, for example, the Gauss distribution. In Equation (5), a value σ₁ is a constant appropriately set by a designer.

$$φ ( x ) = exp ( - \frac{{ρ}^{2} ( x )}{2 {σ}_{1}^{2}} ) \qquad ( 5 )$$

In Equation (5), the variance ρ takes 0 and the degree of focus φ takes the maximum value. As the variance ρ increases, the value of the degree of focus φ decreases along the Gauss distribution curve. That is, the value of the degree of focus φ increases, as the focusing is achieved. The value of the degree of focus φ decreases, as the focusing is less achieved.

The method of setting the degree of focus φ is not limited to the method using the Gauss distribution curve. For example, the relation between the variance ρ and the degree of focus φ may be set to be inversely proportional. The degree of focus φ may be set according to a curve different from the Gauss distribution curve.

The degree of focus φ can be also set using a distance image. The distance image is an image for which a distance between a camera (for example, the main lens 110) and an object is expressed by a numeral value. The distance image can be calculated for each pixel from the plurality of unit images of the compound-eye image 130 by a stereo matching method. The invention is not limited thereto, but a distance image obtained by a ranging sensor such as a stereo camera or a range finder may be used. In this case, the degree of focus φ can be calculated by, for example, Equation (6) below.

$$φ ( x ) = exp ( - \frac{{( d ( x ) - \hat{d} )}^{2}}{2 {σ}_{2}^{2}} ) \qquad ( 6 )$$

In Equation (6), a value d(x) indicates a value of a distance image in a position vector x, a value \hat{d} indicates the value of a focused distance, and a value σ₂ indicates a constant appropriately set by a designer. In Equation (6), the value of the degree of focus φ is larger, as the focused distance is closer to a distance illustrated in the distance image.

A user can visually confirm the refocused image 140 and designate a focused region. For example, the image processing device 100 is configured to further include a display unit that displays an output image and an input unit that receives a user's input and the user designates a focused region by displaying the refocused image 140 on the display unit and performing an input on the input unit. In this case, for example, it can be considered that the user sets the degree of focus φ of the region designated as the focused region to the maximum value (for example, 1) and sets the degree of focus φ of the other region to 0.

Desirably, the user can easily designate a region with a rectangular shape or a region with an indefinite shape, using a pointing device such as a touch panel, a mouse, or a pen table configured as the input unit.

When the compound-eye image 130 captured by the camera array is used, the degree of focus φ can be calculated by calculating a variation in the pixel value when the respective unit images of the compound-eye image 130 are shifted by the amount of shift and are integrated by the generator 103.

The process of determining the sampling information in step S204 of the flowchart of FIG. 4 will be described. The determinator 102 determines the sampling information 145 including a pair of a position corresponding to a pixel of the input compound-eye image 130 in the refocused image 140 and a pixel value of the pixel.

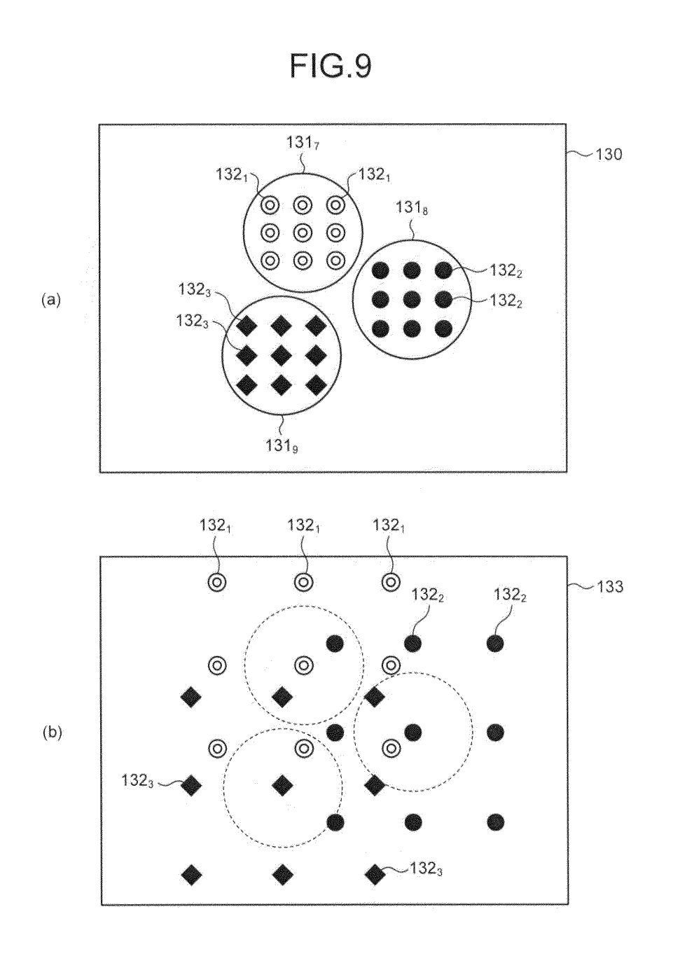

The process of determining the sampling information will be described in more detail with reference to FIG. 9. Illustrated in (a) of FIG. 9 is an example of the compound-eye image 130. To facilitate the description here, three microlens images 131₇, 131₈, and 131₉ in the compound-eye image 130 will be exemplified in the description.

In (a) of FIG. 9, pixels 132₁ included in the microlens image 131₇ are indicated by double circle and pixels 132₂ included in the microlens image 131₈ are indicated by black circle. Further, pixels 132₃ included in the microlens image 131₉ are indicated by diamond shape.

It is determined to which positions of the refocused image 140 the pixels 132₁, the pixels 132₂, and the pixels 132₃ of the microlens images 131₇, 131₈, and 131₉ correspond. The microlens images 131₇, 131₈, and 131₉ are scaled up at the same magnification as the scaling upscale factor of the microlens images at the time of the generation of the refocused image 140 by fixing the central positions of these microlens images.

Illustrated in (b) of FIG. 9 is an example of the pixels of the microlens images 131₇, 131₈, and 131₉ after the scaling up. In a compound-eye image 133 after the scaling up, for example, the positions of the pixels 132₁ of the microlens image 131₇ are positions scaled up in respective directions at a scale factor from the respective positions in the compound-eye image 130 before the scaling up by using the middle of the microlens image 131₇ as a center. The same applies to the other microlens images 131₈ and 131₉.

At this time, the positions of the pixels 132₁, the pixels 132₂, and the pixels 132₃ in the compound-eye image 133 after the scaling up are determined with real precision. In other words, the positions of the pixels 132₁, the pixels 132₂, and the pixels 132₃ in the compound-eye image 133 after the scaling up are not suitable for the matrix of the pixels in some cases. Hereinafter, the pixels 132₁, the pixels 132₂, and the pixels 132₃ after the scaling up are appropriately referred to as sampling points.

The determinator 102 determines the sampling information 145 by matching the position of each pixel calculated after the scaling up with the pixel value of this pixel. In this case, the determinator 102 determines the sampling information 145 corresponding to all of the pixels on the compound-eye image 130.

Here, the sampling information 145 is determined for all of the pixels on the compound-eye image 130, but the invention is not limited thereto. For example, the sampling information 145 may be determined selectively for a pixel for which the degree of focus φ(x) calculated for each pixel by the setting unit 104 is equal to or greater than a threshold value. Thus, it is possible to suppress an amount of calculation of the processor 105 to be described below.

When a plurality of images captured by the camera array is used, the pixels of each image and the pixel values of the pixels are determined as the sampling information 145 by scaling up and shifting the unit images by an amount of shift at the same magnification as the scale factor of each image when the refocused image 140 is generated.

The resolution enhancement in step S205 of the flowchart of FIG. 4 will be described. The processor 105 generates a high-resolution image 146 obtained by further intensifying the focused region in the refocused image 140 and performing the resolution enhancement on the focused region based on the input sampling information 145, the refocused image 140, and the degree of focus φ, and then the high-resolution image 146 is output as an output image from the image processing device 100.

The resolution enhancement in the processor 105 will be described in more detail. For example, the processor 105 obtains the high-resolution image 146 by minimizing an energy function E(h) defined in Equation (7) below.

$$E ( h ) = {\sum }_{i = 0}^{N - 1} {( {b}_{i}^{T} h - {s}_{i} )}^{2} \qquad ( 7 )$$

Here, a vector h indicates a vector for arranging pixel values of the high-resolution image 146. A vector bᵢ indicates a vector for arranging values of a point spread function (PSF) of an i^{th} sampling point and a superscript “T” indicates transposition of a vector. A value sᵢ indicates a pixel value of the i^{th} sampling point. A value N indicates the number of sampling points.

The point spread function is a function indicating a response to a point light source of an optical system. For example, the point spread function can simply simulate deterioration of an image caused by an imaging optical system in the acquisition unit 101. For example, a Gauss function defined in Equation (8) below can be applied as the point spread function. The vector bᵢ can be configured by arranging values b (x, y) of the function of Equation (8).

$$b ( x , y ) = \frac{1}{2 {πσ}_{3}^{2}} exp ( - \frac{{x}^{2} + {y}^{2}}{2 {σ}_{3}^{2}} ) \qquad ( 8 )$$

In Equation (8), a value σ₃ is set based on Equation (9) below. In Equation (9), a value μ indicates a scale factor for the microlens image 131 when the refocused image 140 is generated and a value k is a constant set appropriately by a designer.

σ₃=kμ (9)

The example has been described above in which Gauss function is used as the point spread function, but the invention is not limited to this example. For example, a point spread function calculated by an optical simulation of an actually used imaging optical system may be used.

To minimize the energy function E(h) represented in Equation (7), a steepest descent method, a conjugated gradient method, a POCS (Projections Onto Convec Sets) method, or the like can be used. When the POCS method is used, an image is updated through repeated calculation defined in Equation (10) below.

$${h}_{t + 1} = {h}_{t} + \frac{α}{{‖ {b}_{i} ‖}^{2}} diag ( g ) ( {s}_{i} - {b}_{i}^{T} {h}_{t} ) {b}_{i} \qquad ( 10 )$$

In Equation (10), a value t indicates the number of repetitions. As a general usage, a vector in which values of update amounts of respective pixels are arranged is used as a vector g and a function diag (·) indicates a square matrix that has vector elements as diagonal elements. A value α is a constant set appropriately by a designer. Based on Equation (10), updating of all of the sampling points is repeated a predetermined number of times or until an image is not changed (until a vector h is converged).

In the first embodiment, the refocused image 140 is used as a vector h₀ which is an initial value of the vector h, and a vector in which values of the degree of focus φ are arranged is used as the vector g. Thus, it is possible to further increase the update amount of a pixel with the high focusing degree in the refocused image 140 and further decrease the update amount of a pixel with the low focusing degree. As a result, it is possible to generate the high-resolution image 146 in which the region with the high focusing degree is subjected to the resolution enhancement more strongly.

When the energy function E(h) expressed in Equation (7) is minimized by the steepest descent method, an image is updated through repeated calculation defined in Equation (11) below. In Equation (11), a value ε is a constant set appropriately by a designer.

$${h}_{t + 1} = {h}_{t} - ɛdiag ( g ) {\sum }_{i = 0}^{N - 1} {b}_{i} ( {b}_{i}^{T} {h}_{t} - {s}_{i} ) \qquad ( 11 )$$

By performing the same process even on the compound-eye image 130 captured by the camera array using Equation (7) to Equation (10) or Equation (11) described above, it is possible to generate the high-resolution image 146.

### Modification Example of First Embodiment

The energy function E(h) is not limited to the function expressed in Equation (7). For example, as expressed Equation (12) below, an energy function E′(h) in which a regularization term is added to Equation (7) may be used. In Equation (12), a matrix R is a matrix indicating differential and a value λ is a constant set appropriately by a designer.

$${E}^{′} ( h ) = {\sum }_{i = 0}^{N - 1} {( {b}_{i}^{T} h - {s}_{i} )}^{2} + λ {‖ Rh ‖}^{2} \qquad ( 12 )$$

When the energy function E′(h) expressed in Equation (12) is minimized by the steepest descent method, an image is updated through repeated calculation defined in Equation (13) below.

$${h}_{t + 1} = {h}_{t} - ɛdiag ( g ) ( {\sum }_{i = 0}^{N - 1} {b}_{i} ( {b}_{i}^{T} {h}_{t} - {s}_{i} ) + λ {R}^{T} {Rh}_{t} ) \qquad ( 13 )$$

Thus, the image processing device 100 according to the first embodiment can perform the resolution enhancement on the region of the refocused image 140 with the high focusing degree more strongly based on the degree of focus φ. Accordingly, the refocused image 140 focused at a predetermined distance from the compound-eye image 130 obtained by performing imaging once can be further subjected to the resolution enhancement and output.

Conventionally, there is a method of generating a high-resolution image using a super-resolution technology (see T. E. Bishop and S. Zanetti, P. Favaro, “Light Field Superresolution”, International Conference on Computational Photography in 2009). According to the method of T. E. Bishop and S. Zanetti, P. Favaro, “Light Field Superresolution”, International Conference on Computational Photography in 2009, images for which an object is viewed from a plurality of viewpoints are generated by arranging the pixels of a compound-eye image in order. Then, super-resolution processing is performed by setting one viewpoint image among the images as a target image and adding sampling points of viewpoint images other than the target image to the target image.

In the method of T. E. Bishop and S. Zanetti, P. Favaro, “Light Field Superresolution”, International Conference on Computational Photography in 2009, a focus distance of the target image is determined at the time of imaging. Therefore, a focus distance of the final output image may not be changed. According to the first embodiment, the refocused image 140 is first generated and the resolution enhancement is performed on the generated refocused image 140. Since the degree of focus φ is added at the time of the resolution enhancement, this problem is resolved.

### Second Embodiment

Next, a second embodiment will be described. The second embodiment is an example in which the image processing device 100 according to the first embodiment includes an optical system and is applied to an imaging device capable of storing and displaying an output image.

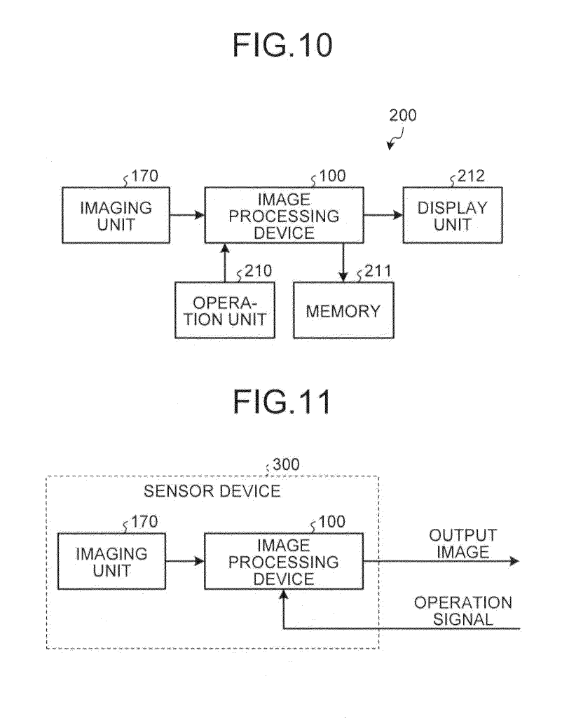

FIG. 10 is a diagram illustrating example of the configuration of an imaging device 200 according to a second embodiment. In FIG. 10, the same reference numerals are given to constituent elements common to those described above in FIG. 1 and the detailed description thereof will not be repeated. As exemplified in FIG. 10, the imaging device 200 includes an imaging unit 170, an image processing device 100, an operation unit 210, a memory 211, and a display unit 212.

The entire process of the imaging device 200 is controlled according to a program by a CPU (not illustrated). The imaging unit 170 includes the optical system exemplified in FIG. 2 and a sensor 112 in correspondence with the above-described acquisition unit 101.

The memory 211 is, for example, a non-volatile semiconductor memory and stores an output image output from the image processing device 100. The display unit 212 includes a display device such as an LCD (Liquid Crystal Display) and a driving circuit that drives the display device. The display unit 212 displays the output image output from the image processing device 100.

The operation unit 210 receives a user's input. For example, a distance at which the refocused image 140 is desired to be focused can be designated in the image processing device 100 through the user's input on the operation unit 210. The operation unit 210 can also receive a designation of a focused region by a user. The operation unit 210 can receive a user's input or the like of an imaging timing of the imaging unit 170, a storage timing of the output image in the memory 211, and focusing control at the time of imaging.

In this configuration, the imaging device 200 designates the focusing distance at the time of imaging according to a user's input on the operation unit 210. The imaging device 200 designates a timing at which the compound-eye image 130 output from the imaging unit 170 is acquired in the image processing device 100 according to a user's input on the operation unit 210.

The imaging device 200 generates the refocused image 140 according to the focusing distance designated through the user's input on the operation unit 210, calculates the degree of focus φ, and causes the display unit 212 to display an output image obtained by performing the resolution enhancement on the refocused image 140 according to the degree of focus φ by the processor 105. For example, the user can re-input the focusing distance from the operation unit 210 with reference to display of the display unit 212. The user can designate a focused region with reference to the display of the display unit 212 and designate a region on which the user desires to perform the resolution enhancement strongly. For example, when the user obtains an interesting output image, the user operates the operation unit 210 to store the output image in the memory 211.

The imaging device 200 according to the second embodiment calculates the degree of focus φ of the refocused image 140 generated from the compound-eye image 130 captured by the imaging unit 170. The resolution enhancement is intensively performed on a region which is focused and thus has the high degree of focus φ. Therefore, the user can generate the refocused image with higher resolution from the compound-eye image 130 captured by the imaging device 200 and obtain the output image.

### Third Embodiment

Next, a third embodiment will be described. The third embodiment is an example in which the image processing device 100 according to the first embodiment is applied to a sensor device that includes an optical system and is configured to transmit an output image to the outside and receive an operation signal from the outside.

FIG. 11 is a diagram illustrating an example of the configuration of a sensor device 300 according to the third embodiment. In FIG. 11, the same reference numerals are given to constituent elements common to those described above in FIGS. 1 and 10 and the detailed description thereof will not be repeated. As exemplified in FIG. 11, the sensor device 300 includes an imaging unit 170 and an image processing device 100.

An operation signal transmitted from the outside through wired or wireless communication is received by the sensor device 300 and is input to the image processing device 100. An output image output from the image processing device 100 is output from the sensor device 300 through wired or wireless communication.

In this configuration, for example, the sensor device 300 generates an output image in which a focused region designated by the operation signal transmitted from the outside is subjected to the resolution enhancement intensively by the processor 105. The output image is transmitted from the sensor device 300 to the outside. In the outside, the received output image can be displayed and an operation signal configured to designate a focused position or a focused region can also be transmitted to the sensor device 300 according to the display.

The sensor device 300 can be applied to, for example, a monitoring camera. In this case, display is monitored using an output image from the sensor device 300 located at a remote place. When the display image includes a doubtful image, a focused distance or a focused region of the doubtful image portion is designated and an operation signal is transmitted to the sensor device 300. The sensor device 300 regenerates the refocused image 140 in response to the operation signal, performs the resolution enhancement on the designated focused region more intensively, and transmits an output image. The details of the doubtful image portion can be confirmed using the output image on which the focused distance is reset and the resolution enhancement is performed.

### Fourth Embodiment

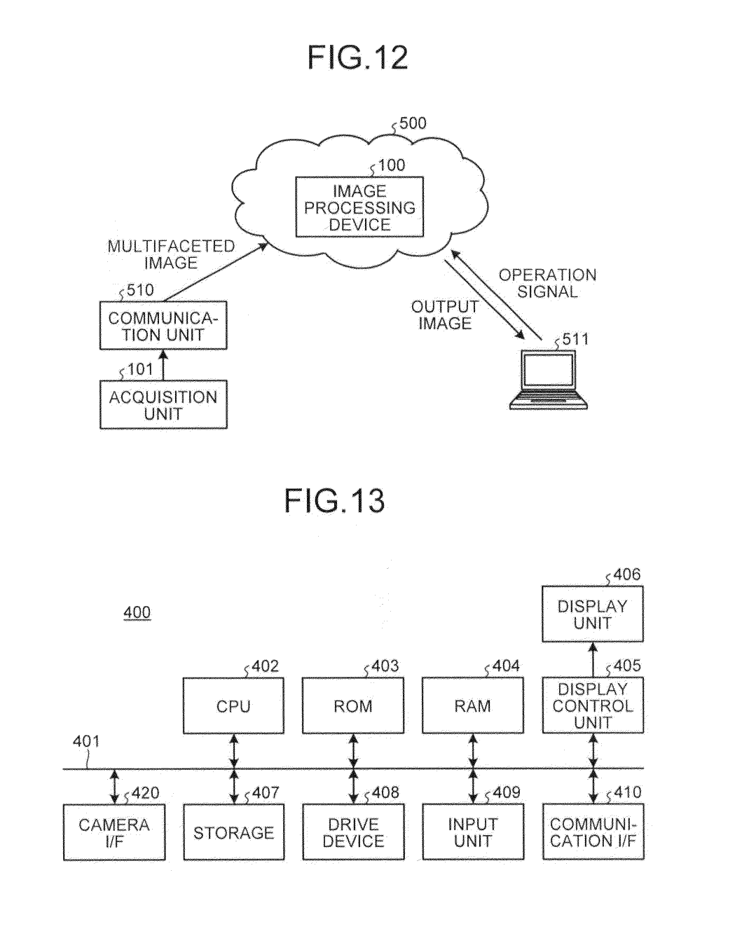

Next, a fourth embodiment will be described. The fourth embodiment is an example of an image processing system in which the image processing device 100 according to the first embodiment is constructed on a network cloud. FIG. 12 is a diagram illustrating an example of the configuration of the image processing system according to the fourth embodiment. In FIG. 12, the same reference numerals are given to constituent elements common to those described above in FIG. 1 and the detailed description thereof will not be repeated.

In FIG. 12, in the image processing system, the image processing device 100 is constructed on a network cloud 500. The network cloud 500 is a network group that includes a plurality of computers connected to each other in a network and displays only input and output as a black box of which the inside is hidden from the outside. The network cloud 500 is assumed to use, for example, TCP/IP (Transmission Control Protocol/Internet Protocol) as a communication protocol.

The compound-eye image 130 acquired by the acquisition unit 101 is transmitted to the network cloud 500 via a communication unit 510 and is input to the image processing device 100. The compound-eye image 130 transmitted via the communication unit 510 may be accumulated and stored in a server device or the like on the network cloud 500. The image processing device 100 generates the refocused image 140 based on the compound-eye image 130 transmitted via the communication unit 510, calculates the degree of focus φ, and generates an output image by performing the resolution enhancement on the refocused image 140 according to the degree of focus φ.

The generated output image is output from the image processing device 100 and, for example, a terminal device 511 which is a PC (Personal Computer) receives the output image from the network cloud 500. The terminal device 511 can display the received output image on a display and transmit an operation signal configured to designate a focused distance or a focused region in response to a user's input to the network cloud 500. The image processing device 100 regenerates the refocused image 140 based on the designated focused distance in response to the operation signal and generates an output image by performing the resolution enhancement on the designated focused region more intensively. The output image is retransmitted from the network cloud 500 to the terminal device 511.

According to the fourth embodiment, the user can obtain a high-resolution output image generated by the image processing device 100 and subjected to the resolution enhancement, even when the user does not possess the image processing device 100.

### Another Embodiment

The image processing device 100 according to the above-described embodiments may be realized using a general computer device as basic hardware. FIG. 13 is a diagram illustrating an example of the configuration of a computer device 400 to which the image processing device 100 can be applied according to another embodiment.

In the computer device 400 exemplified in FIG. 13, a CPU (Central Processing Unit) 402, a ROM (Read Only Memory) 403, a RAM (Random Access Memory) 404, and a display control unit 405 are connected to a bus 401. A storage 407, a drive device 408, an input unit 409, a communication I/F 410, and a camera I/F 420 are also connected to the bus 401. The storage 407 is a storage medium capable of storing data in a non-volatile manner and is, for example, a hard disk. The invention is not limited thereto, but the storage 407 may be a non-volatile semiconductor memory such as a flash memory.

The CPU 402 controls the entire computer device 400 using the RAM 404 as a work memory according to programs stored in the ROM 403 and the storage 407. The display control unit 405 converts a display control signal generated by the CPU 402 into a signal which a display unit 406 can display and outputs the converted signal.

The storage 407 stores a program executed by the above-described CPU 402 or various kinds of data. A detachable recording medium (not illustrated) can be mounted on the drive device 408, and thus the drive device 408 can read and write data from and on the recording medium. Examples of the recording medium treated by the drive device 408 include a disk recording medium such as a compact disc (CD) or a digital versatile disc (DVD) and a non-volatile semiconductor memory.

The input unit 409 inputs data from the outside. For example, the input unit 409 includes a predetermined interface such as a USB (Universal Serial Bus) or IEEE 1394 (Institute of Electrical and Electronics Engineers 1394) and inputs data from an external device through the interface. Image data of an input image can be input from the input unit 409.

An input device such as a keyboard or a mouse receiving a user's input is connected to the input unit 409. For example, a user can give an instruction to the computer device 400 by operating the input device according to display of the display unit 406. The input device receiving a user's input may be configured to be integrated with the display unit 406. At this time, the input device may be preferably configured as a touch panel that outputs a control signal according to a pressed position and transmits an image of the display unit 406.

The communication I/F 410 performs communication with an external communication network using a predetermined protocol.

The camera I/F 420 is an interface between the acquisition unit 101 and the computer device 400. The compound-eye image 130 acquired by the acquisition unit 101 is received via the camera I/F 420 by the computer device 400 and is stored in, for example, the RAM 404 or the storage 407. The camera I/F 420 can supply a control signal to the acquisition unit 101 in response to a command of the CPU 402.

The determinator 102, the generator 103, the setting unit 104, and the processor 105 described above are realized by an image processing program operating on the CPU 402. The image processing program configured to execute image processing according to the embodiments is recorded as a file of an installable format or an executable format in a computer-readable recording medium such as a CD or a DVD to be supplied as a computer program product. The invention is not limited thereto, but the image processing program may be stored in advance in the ROM 403 to be supplied as a computer program product.

The image processing program configured to execute the image processing according to the embodiments may be stored in a computer connected to a communication network such as the Internet and may be downloaded via the communication network to be supplied. The image processing program configured to execute the image processing according to the embodiments may be supplied or distributed via a communication network such as the Internet.

For example, the image processing program configured to execute the image processing according to the embodiments is designed to have a module structure including the above-described units (the determinator 102, the generator 103, the setting unit 104, and the processor 105). Therefore, for example, the CPU 402 as actual hardware reads the image processing program from the storage 407 and executes the image processing program, and thus the above-described units are loaded on a main storage unit (for example, the RAM 404) so that the units are generated on the main storage unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a generator configured to generate, from a plurality of unit images in which points on an object are imaged by an imaging unit at different positions according to distances between the imaging unit and the positions of the points on the object, a refocused image focused at a predetermined distance;
a determinator configured to determine sampling information including pairs of positions of pixels of the plurality of unit images in the refocused image and pixel values of the pixels; and
a processor configured to perform resolution enhancement on a predetermined region including a first position indicated by the sampling information of the refocused image according to an intensity corresponding to a focusing degree of a pixel corresponding to the first position.

2. The device according to claim 1, further comprising:
a setting unit configured to set a degree of focus indicating a value which is larger as the focusing degree is higher for each pixel of the refocused image,
wherein the processor performs the resolution enhancement on the predetermined region more intensively as the degree of focus of the pixel corresponding to the first position is larger.

3. The device according to claim 2, wherein the processor performs the resolution enhancement by generating a second pixel value so that a difference between a first pixel value paired with the first position in the sampling information and the second pixel value obtained by simulating the first pixel value based on characteristics of an imaging optical system decreases as the degree of focus at the first position is larger and by updating the refocused image using the second pixel value.

4. The device according to claim 3,
wherein the generator generates the refocused image by scaling up the plurality of unit images at a scale factor determined according to the predetermined distances and by integrating the plurality of unit images, and
the processor performs the simulation using a point spread function and determines a degree of spread by the point spread function according to the scale factor.

5. The device according to claim 2, wherein the setting unit sets the degree of focus of a magnitude corresponding to a variation in a pixel value between the pixels of which pixel positions accord with each other in the integrated unit images when the plurality of unit images are scaled up according to the scale factor determined according to the predetermined distances.

6. The device according to claim 2, wherein the setting unit calculates the degree of focus of a magnitude corresponding to a variation in a pixel value between the pixels of which pixel positions accord with each other in the integrated unit images when the plurality of unit images is shifted and integrated according to amounts of shift determined according to the predetermined distances.

7. The device according to claim 2, further comprising:
a distance acquisition unit configured to acquire a distance from the imaging unit to the object,
wherein the setting unit calculates the degree of focus of a magnitude corresponding to a difference between the distance acquired by the distance acquisition unit and the predetermined distance.

8. The device according to claim 2, wherein the setting unit calculates the degree of focus according to a region designated by a user in the refocused image.

9. The device according to claim 2, wherein the determinator determines the sampling information for a region of which the degree of focus is equal to or greater than a threshold value.

10. The device according to claim 1, further comprising:
the imaging unit;
a reception unit configured to receive information which is transmitted from the outside to indicate at least the predetermined distance; and
a transmission unit configured to transmit the refocused image subjected to the resolution enhancement by the processor to the outside.

11. The device according to claim 1, further comprising:
the imaging unit;
an input unit configured to receive a user input of information indicating at least the predetermined distance; and
a display unit configured to display the refocused image subjected to the resolution enhancement by the processor.

12. An image processing method comprising:
generating, from a plurality of unit images in which points on an object are imaged by an imaging unit at different positions according to distances between the imaging unit and the positions of the points on the object, a refocused image focused at a predetermined distance;
determining sampling information including pairs of positions of pixels of the plurality of unit images in the refocused image and pixel values of the pixels; and
performing resolution enhancement on a predetermined region including a first position indicated by the sampling information of the refocused image according to an intensity corresponding to a focusing degree of a pixel corresponding to the first position.

13. The method according to claim 12, further comprising:
setting a degree of focus indicating a value which is larger as the focusing degree is higher for each pixel of the refocused image,
wherein the performing includes performing the resolution enhancement on the predetermined region more intensively as the degree of focus of the pixel corresponding to the first position is larger.

14. The method according to claim 13, wherein the performing includes performing the resolution enhancement by generating a second pixel value so that a difference between a first pixel value paired with the first position in the sampling information and the second pixel value obtained by simulating the first pixel value based on characteristics of an imaging optical system decreases as the degree of focus at the first position is larger and by updating the refocused image using the second pixel value.

15. The method according to claim 14,
wherein the generating includes generating the refocused image by scaling up the plurality of unit images at a scale factor determined according to the predetermined distances and by integrating includes performing the plurality of unit images, and
the performing includes performing the simulation using a point spread function and determines a degree of spread by the point spread function according to the scale factor.

16. The method according to claim 13, wherein the setting the degree of focus of a magnitude corresponding to a variation in a pixel value between the pixels of which pixel positions accord with each other in the integrated unit images when the plurality of unit images are scaled up according to the scale factor determined according to the predetermined distances.

17. The device according to claim 13, wherein the setting includes calculating the degree of focus of a magnitude corresponding to a variation in a pixel value between the pixels of which pixel positions accord with each other in the integrated unit images when the plurality of unit images is shifted and integrated according to amounts of shift determined according to the predetermined distances.

18. The method according to claim 13, further comprising:
acquiring a distance from the imaging unit to the object,
wherein the setting includes calculating the degree of focus of a magnitude corresponding to a difference between the distance acquired by acquiring and the predetermined distance.

19. The method according to claim 13, wherein the setting includes calculating the degree of focus according to a region designated by a user in the refocused image.

20. The method according to claim 13, wherein the determining includes determining the sampling information for a region of which the degree of focus is equal to or greater than a threshold value.

21. A computer program product comprising a computer-readable medium containing a program executed by a computer, the program causing the computer to execute:
generating, from a plurality of unit images in which points on an object are imaged by an imaging unit at different positions according to distances between the imaging unit and the positions of the points on the object, a refocused image focused at a predetermined distance;
determining sampling information including pairs of positions of pixels of the plurality of unit images in the refocused image and pixel values of the pixels; and
performing resolution enhancement on a predetermined region including a first position indicated by the sampling information of the refocused image according to an intensity corresponding to a focusing degree of a pixel corresponding to the first position.
